(19) United States
(12) Patent Application Publication
(10) Pub. No.: US 2017/0091683 A1
(43) Pub. Date: Mar. 30, 2017

(54) DATABASE SYSTEM FOR DISTRIBUTION CENTER FULFILLMENT CAPACITY AVAILABILITY TRACKING AND METHOD THEREFOR

(71) Applicant: WAL-MART STORES, INC., Bentonville, AR (US)

(72) Inventors: Vikrant Tare, San Bruno, CA (US); Yuvaraj MukariKrishnamoorthy, Bangalore (IN); Shiv Prakash, Bangalore (IN); Devadas Pattathil, San Jose, CA (US); Guruprasad Pundoor, Fremont, CA (US); Mathew George, San Ramon, CA (US); Hem Singh, San Francisco, CA (US); Sebastien Mancel, Daly City, CA (US); Vadim Zilberleyb, San Francisco, CA (US)

(73) Assignee: WAL-MART STORES, INC., Bentonville, AR (US)

(21) Appl. No.: 14/871,451

(22) Filed: Sep. 30, 2015

(51) Int. Cl. G06Q 10/06; G06Q 30/02; G06Q 10/08

(52) U.S. Cl. CPC G06Q 10/06312; G06Q 10/0835; G06Q 30/0202

(57) ABSTRACT

A system and method for distribution center fulfillment capacity availability tracking is presented herein. A method can include determining an initial value for a fulfillment capacity of each location of one or more locations. The initial value for the fulfillment capacity is an estimation of how many units can be shipped from the location in a particular time period. Thereafter, the fulfillment capacity is adjusted for each order received. The fulfillment capacity is published as an availability to promise. Orders are prioritized using the availability to promise. Orders are then processed for shipment shipped based on the prioritization. Other embodiments are also disclosed herein.

### TECHNICAL FIELD

This disclosure relates generally to distribution centers and more particularly to a method and system for more efficient distribution of goods by using capacity availability tracking.

### BACKGROUND

Many organizations have a need to ship items from one place to another. In particular, retail businesses, business to business sales, and warehouses often ship items from multiple storage facilities to other locations. This can include shipments from a warehouse or other storage facility to a customer or other storage facilities. For an organization with a single storage facility, handling shipments from the single storage facility can be relatively easy. However, larger organizations might have multiple storage facilities. When such an organization wants to ship items from those multiple storage facilities, many different factors should be taken into consideration. It would be desirable to have a more efficient and accurate method and system for facilitating shipments.

### BRIEF DESCRIPTION OF THE DRAWINGS

To facilitate further description of the embodiments, the following drawings are provided in which:

FIG. 1 illustrates a front elevation view of a computer system that is suitable for implementing an embodiment of the system;

FIG. 2 illustrates a representative block diagram of an example of the elements included in the circuit boards inside a chassis of the computer system of FIG. 1;

FIG. 3 is a representative block diagram of a system according to an embodiment;

FIG. 4 is a block diagram illustrating a system according to an embodiment; and

FIG. 5 is a flow diagram illustrating the operation of an embodiment.

For simplicity and clarity of illustration, the drawing figures illustrate the general manner of construction, and descriptions and details of well-known features and techniques might be omitted to avoid unnecessarily obscuring the present disclosure. Additionally, elements in the drawing figures are not necessarily drawn to scale. For example, the dimensions of some of the elements in the figures might be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but might include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

In one embodiment, a system might comprise: one or more processing modules;

and one or more non-transitory storage modules storing computing instructions configured to run on the one or more processing modules and perform the acts of: determining an initial value for a fulfillment capacity of each location of one or more locations, such that the initial value for the fulfillment capacity is an estimation of how many units can be shipped from the location in a particular time period; receiving orders; adjusting the fulfillment capacity for each of the orders received; publishing the fulfillment capacity as an availability to promise; using the availability to promise to prioritize a set of one or more of the orders; and processing one of the orders for shipment based on the prioritization.

In one embodiment, a method might comprise: determining an initial value for a fulfillment capacity of each location of one or more locations, such that the initial value for the fulfillment capacity is an estimation of how many units can be shipped from the location in a particular time period; receiving orders; adjusting the fulfillment capacity for each of the orders received; publishing the fulfillment capacity as an availability to promise; using the availability to promise to prioritize a set of one or more of the orders; and processing one of the orders for shipment based on the prioritization.

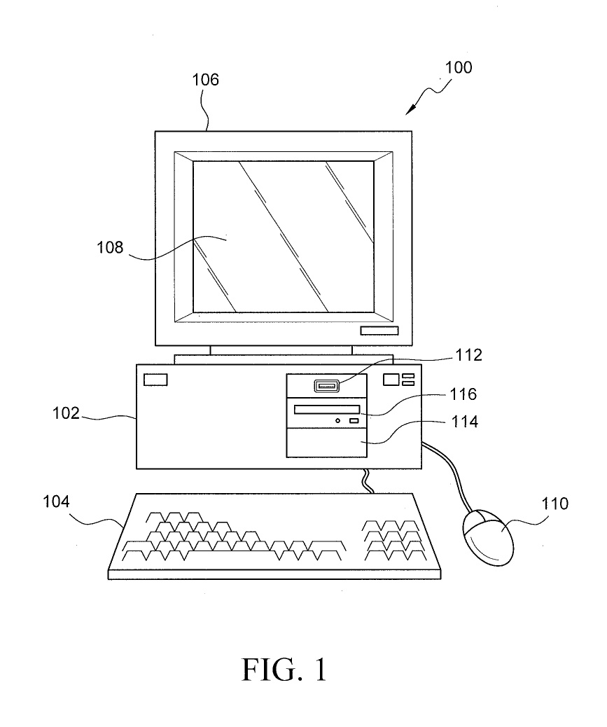

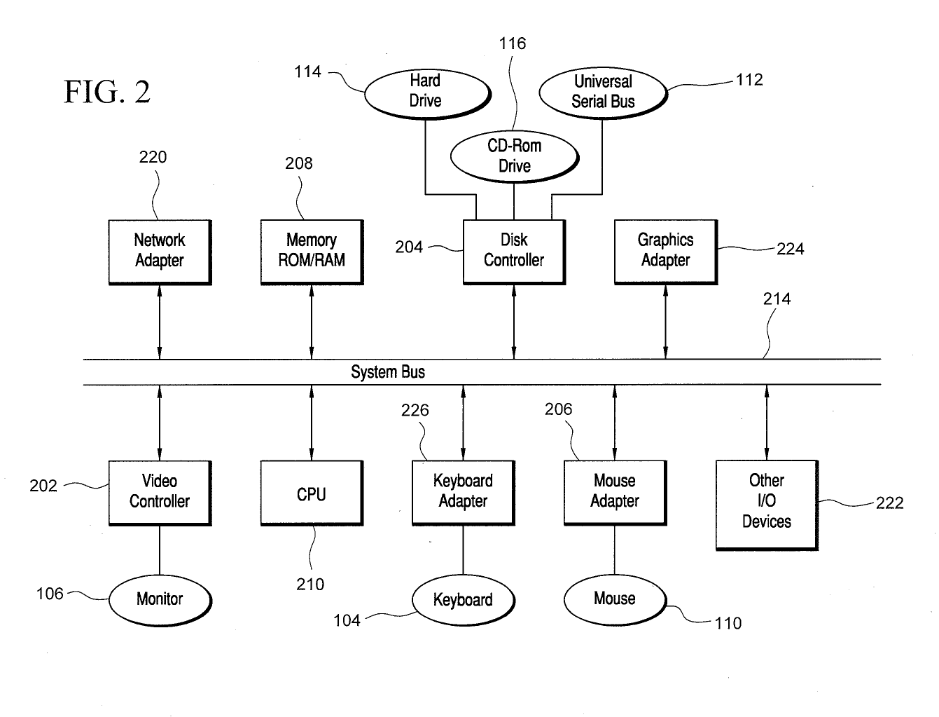

Turning to the drawings, FIG. 1 illustrates an exemplary embodiment of a computer system 100, all of which or a portion of which can be suitable for implementing the techniques described herein. As an example, a different or separate one of a chassis 102 (and its internal components) can be suitable for implementing the techniques described herein. Furthermore, one or more elements of computer system 100 (e.g., a refreshing monitor 106, a keyboard 104, and/or a mouse 110, etc.) also can be appropriate for implementing the techniques described herein. Computer system 100 comprises chassis 102 containing one or more circuit boards (not shown), a Universal Serial Bus (USB) port 112, a Compact Disc Read-Only Memory (CD-ROM), Digital Video Disc (DVD) drive, or Blu-ray drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 comprises both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can comprise microcode such as a Basic Input-Output System (BIOS) or Unified Extensible Firmware Interface (UEFI). In some examples, the one or more memory storage units of the various embodiments disclosed herein can comprise memory storage unit 208, a USB-equipped electronic device, such as, an external memory storage unit (not shown) coupled to universal serial bus (USB) port 112 (FIGS. 1-2), hard drive 114 (FIGS. 1-2), and/or CD-ROM, DVD drive, or Blu-ray drive 116 (FIGS. 1-2). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise various versions/distributions of Microsoft® Windows® operating system (OS), Apple® OS X, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

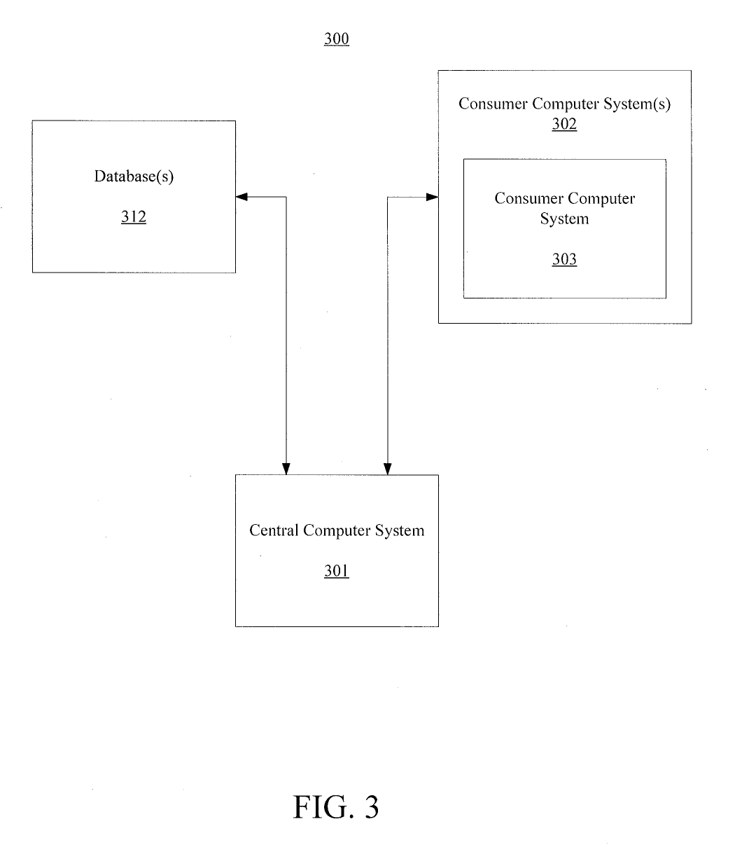

Skipping ahead now in the drawings, FIG. 3 illustrates a representative block diagram of a system 300, according to an embodiment. System 300 is merely exemplary and embodiments of the system are not limited to the embodiments presented herein. System 300 can be employed in many different embodiments or examples not specifically depicted or described herein. In some embodiments, certain elements or modules of system 300 can perform various methods and/or activities of those methods. In these or other embodiments, the methods and/or the activities of the methods can be performed by other suitable elements or modules of system 300.

As further described in greater detail below, in these or other embodiments, system 300 can proactively (e.g., prospectively) and/or reactively (e.g., responsively) determine and/or communicate the consumer product information to the consumer, as desired. Proactive acts can refer to acts (e.g., identification, determination, communication, etc.) performed without consideration of one or more predetermined acts performed by the consumer; and reactive acts can refer to acts (e.g., identification, determination, communication, etc.) performed with consideration of (i.e., in response to) one or more predetermined acts performed by the consumer. For example, in some embodiments, the predetermined act(s) can comprise an act of identifying a selection of a consumer product by the consumer.

Meanwhile, as also described in greater detail below, system 300 can be implemented in brick-and-mortar commerce and/or electronic commerce applications, as desirable. Further, in many of these or other embodiments, system 300 can communicate the consumer product information to the consumer substantially in real-time (e.g., near real-time). Near real-time can mean real-time less a time delay for processing (e.g., determining) and/or transmitting the relevant consumer product information to the relevant consumer. The particular time delay can vary depending on the type and/or amount of the consumer product information, the processing speed(s) of the processing module(s) of system 300, the transmission capability of the communication hardware (as introduced below), the transmission distance, etc. However, in many embodiments, the time delay can be less than approximately one, five, ten, or twenty minutes.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Specifically, system 300 comprises a central computer system 301. In many embodiments, central computer system 301 can be similar or identical to computer system 100 (FIG. 1). Accordingly, central computer system 301 can comprise one or more processing modules and one or more memory storage modules (e.g., one or more non-transitory memory storage modules). In these or other embodiments, the processing module(s) and/or the memory storage module(s) can be similar or identical to the processing module(s) and/or memory storage module(s) (e.g., non-transitory memory storage modules) described above with respect to computer system 100 (FIG. 1). In some embodiments, central computer system 301 can comprise a single computer or server, but in many embodiments, central computer system 301 comprises a cluster or collection of computers or servers and/or a cloud of computers or servers. Meanwhile, central computer system 301 can comprise one or more input devices (e.g., one or more keyboards, one or more keypads, one or more pointing devices such as a computer mouse or computer mice, one or more touchscreen displays, etc.), and/or can comprise one or more display devices (e.g., one or more monitors, one or more touchscreen displays, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) of central computer system 301 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of central computer system 301. In a similar manner, the processing module(s) and the memory storage module(s) can be local and/or remote to each other.

In many embodiments, central computer system 301 is configured to communicate with one or more consumer computer systems 302 (e.g., a consumer computer system 303) of one or more consumers. For example, the consumer(s) can interface (e.g., interact) with central computer system 301, and vice versa, via consumer computer system(s) 302 (e.g., consumer computer system 303). Accordingly, in many embodiments, central computer system 301 can refer to a back end of system 300 operated by an operator and/or administrator of system 300, and consumer computer system(s) 302 can refer to a front end of system 300 used by one or more users of system 300 (i.e., the consumer(s)). In these or other embodiments, the operator and/or administrator of system 300 can manage central computer system 301, the processing module(s) of computer system 301, and/or the memory storage module(s) of computer system 301 using the input device(s) and/or display device(s) of central computer system 301. In some embodiments, system 300 can comprise consumer computer system(s) 302 (e.g., consumer computer system 303).

Like central computer system 301, consumer computer system(s) 302 each can be similar or identical to computer system 100 (FIG. 1), and in many embodiments, each of consumer computer system(s) 302 can be similar or identical to each other. In many embodiments, consumer computer system(s) 302 can comprise one or more desktop computer devices, one or more wearable user computer devices, and/or one or more mobile devices, etc. At least part of central computer system 301 can be located remotely from consumer computer system(s) 302.

In some embodiments, a mobile device can refer to a portable electronic device (e.g., an electronic device easily conveyable by hand by a person of average size) with the capability to present audio and/or visual data (e.g., images, videos, music, etc.). For example, a mobile device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can comprise a volume and/or weight sufficiently small as to permit the mobile device to be easily conveyable by hand. For examples, in some embodiments, a mobile device can occupy a volume of less than or equal to approximately 189 cubic centimeters, 244 cubic centimeters, 1790 cubic centimeters, 2434 cubic centimeters, 2876 cubic centimeters, 4056 cubic centimeters, and/or 5752 cubic centimeters. Further, in these embodiments, a mobile device can weigh less than or equal to 3.24 Newtons, 4.35 Newtons, 15.6 Newtons, 17.8 Newtons, 22.3 Newtons, 31.2 Newtons, and/or 44.5 Newtons.

Exemplary mobile devices can comprise, but are not limited to, one of the following: (i) an iPod®, iPhone®, iPod Touch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia®, Surface Pro™, or similar product by the Microsoft Corporation of Redmond, Wash., United States of America, and/or (iv) a Galaxy™, Galaxy Tab™, Note™, or similar product by the Samsung Group of Samsung Town, Seoul, South Korea. Further, in the same or different embodiments, a mobile device can comprise an electronic device configured to implement one or more of (i) the iOS™ operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by Google, Inc. of Mountain View, Calif., United States, (v) the Windows Mobile™, Windows Phone™, and Windows 10 (mobile)™ operating systems by Microsoft Corporation of Redmond, Wash., United States of America, or (vi) the Symbian™ operating system by Nokia Corp. of Keilaniemi, Espoo, Finland.

In further embodiments, central computer system 301 can be configured to communicate with software (e.g., one or more web browsers, one or more mobile software applications, etc.) of the consumer computer system(s) 302 (e.g., consumer computer system 303). For example, the software can run on one or more processing modules and can be stored on one or more memory storage modules (e.g., one or more non-transitory memory storage modules) of the consumer computer system(s) 302 (e.g., consumer computer system 303). In these or other embodiments, the processing module(s) of the consumer computer system(s) 302 (e.g., consumer computer system 303) can be similar or identical to the processing module(s) described above with respect to computer system 100 (FIG. 1). Further, the memory storage module(s) (e.g., non-transitory memory storage modules) of the consumer computer system(s) 302 (e.g., consumer computer system 303) can be similar or identical to the memory storage module(s) (e.g., non-transitory memory storage module(s)) described above with respect to computer system 100 (FIG. 1). Exemplary web browsers can include (i) Firefox® by the Mozilla Organization of Mountain View, Calif., United States of America, (ii) Internet Explorer® by the Microsoft Corp. of Redmond, Wash., United States of America, (iii) Chrome™ by Google Inc. of Menlo Park, Calif., United States of America, (iv) Opera® by Opera Software of Oslo, Norway, and (v) Safari® by Apple Inc. of Cupertino, Calif., United States of America.

Meanwhile, in many embodiments, central computer system 301 also can be configured to communicate with, one or more databases 312. The database can comprise a product database that contains information about products sold by a retailer. Database(s) 312 can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). Also, in some embodiments, for any particular database of database(s) 312, that particular database can be stored on a single memory storage module of the memory storage module(s) and/or the non-transitory memory storage module(s) storing database(s) 312 or it can be spread across multiple of the memory storage module(s) and/or non-transitory memory storage module(s) storing database(s) 312, depending on the size of the particular database and/or the storage capacity of the memory storage module(s) and/or non-transitory memory storage module(s).

In these or other embodiments, the memory storage module(s) of central computer system 300 can comprise some or all of the memory storage module(s) storing database(s) 312. In further embodiments, some of the memory storage module(s) storing database(s) 312 can be part of consumer computer systems 302 and/or one or more third-party computer systems (i.e., other than central computer system 301 and consumer computer systems 302), and in still further embodiments, all of the memory storage module(s) storing database(s) 312 can be part of consumer computer systems 302 and/or the third-party computer system(s). Like central computer system 301 and consumer computer system(s) 302, when applicable, each of the third-party computer system(s) can be similar or identical to computer system 100 (FIG. 1). Notably, the third-party computer systems are omitted from the drawings to better illustrate that database(s) 312 can be stored at memory storage module(s) of central computer system 301, consumer computer system(s) 302, and/or the third-party computer systems, depending on the manner in which system 300 is implemented.

Database(s) 312 each can comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between central computer system 301, consumer computer system(s) 302 (e.g., consumer computer system 303), and/or database(s) 312 can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc. Exemplary LAN and/or WAN protocol(s) can comprise Data Over Cable Service Interface Specification (DOCSIS), Institute of Electrical and Electronic Engineers (IEEE) 802.3 (also known as Ethernet), IEEE 802.11 (also known as WiFi), etc. Exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, and the like. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.)

For convenience, the functionality of system 300 is described herein as it relates particularly to consumer computer system 303 and a single consumer. But in many embodiments, the functionality of system 300 can be extended to each of consumer computer system(s) 302 and/or to multiple consumers. In these extended examples, in some embodiments, single consumers can interface (e.g., interact) with central computer system 301 with multiple consumer computer systems of consumer computer system(s) 302 (e.g., at different times). For example, a consumer could interface with central computer system 301 via a first consumer computer system (e.g., a desktop computer), such as, for example, when interfacing with central computer system 301 from home, and via a second consumer computer system (e.g., a mobile device), such as, for example, when interfacing with central computer system 301 away from home.

As described earlier, when an organization shipping from multiple locations needs to ship items, there are a variety of factors that should be considered. An exemplary organization that might ship from multiple locations is an electronic commerce (“eCommerce”) provider. Larger eCommerce providers often have multiple warehouses that store goods to be shipped to customers. An eCommerce provider in the United States might have a first warehouse that primarily services orders in the western portion of the United States and a second warehouse that primarily services orders in the eastern portion of the United States.

One typical method of managing multiple warehouses is to track inventory. For example, if product A is available only at the first warehouse, all orders of product A will be delivered from the first warehouse, regardless of where the order is to be delivered. If product A is available at both warehouses, however, shipments can be made from either warehouse, and the choice of warehouse might be made with respect to distance from the destination.

Another aspect that might be considered is balancing inventory. Delivering all of product A from the first warehouse might eventually lead to the first warehouse running out of product A before the second warehouse. Balancing inventory can become even more important as more warehouses are being used.

One feature that has not been considered in the past is fulfillment capacity. In simple terms, fulfillment capacity is a measure of the ability to process inventory. The first warehouse might store 100,000 items. The second warehouse might store 80,000 items. But if the first warehouse is only capable of processing 10,000 items in a day, that capacity should be taken into account when processing orders.

There are several reasons why the ability to process inventory can be limited. A typical reason is the number of people available to process the inventory. In an eCommerce business, processing inventory takes several steps, such as finding the inventory that was ordered, placing the inventory in a box along with other ordered inventory, sealing the box, and then sending the box in a shipment. Although automation can be used for some of those steps, time and personnel are required to perform most of those steps. Additional personnel might be required to place items on the shelf, for cleaning the warehouse, for managing the warehouse, and the like.

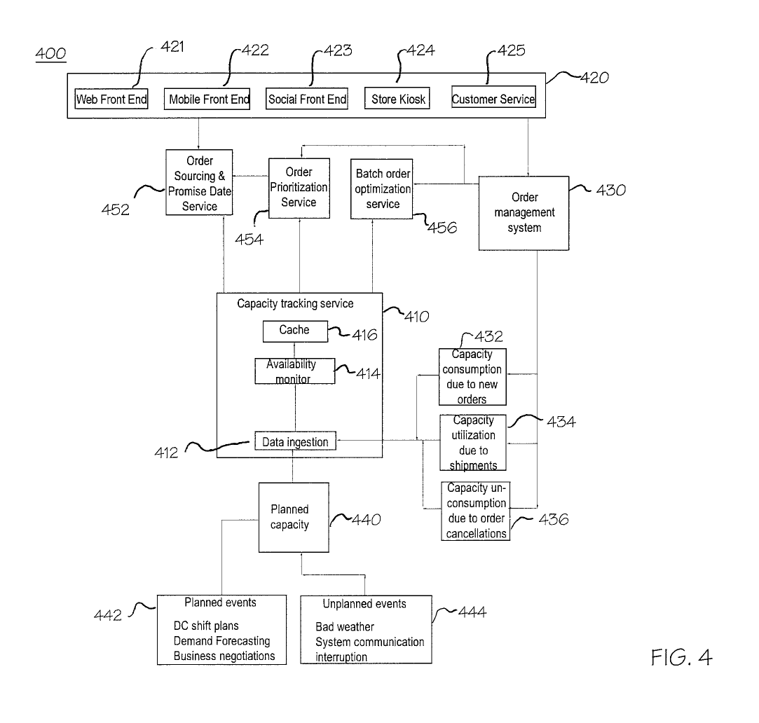

FIG. 4 will now show a block diagram illustrating an exemplary layout of a system 400 capable of performing an embodiment. Capacity tracking service 410 is the portion of the system that receives many inputs and produces outputs that allow the rest of the system to determine from where to fulfill shipments. There can be a variety of internal components to capacity tracking service 410. These components can include data ingestion module 412, availability monitor 414, and cache 416. Data ingestion module 412 can be configured to receive inputs from other portions of system 400, such as the portions described below. Availability monitor 414 can be a module that performs the actual calculations, taking inputs from data ingestion module 412 and outputting the results to cache 416. Cache 416 can be a portion of memory that is readable by other portions of system 400. Cache 416 can be where fulfillment capacity data is published by capacity tracking service 410 and read by other portions of system 400. In some embodiments, the published fulfillment capacity data can be called “available to promise” data or “ATP.”

In an eCommerce embodiment, front-end 420 receives orders from users. There can be various different components of front-end 420, such as web front-end 421, mobile front-end 422, social front-end 423, one or more store kiosks 424, and customer service 425. Each of the components is arranged to present information to users such as availability (to inform the customer whether or not an item is in stock) and to accept information from users, such as receiving orders.

Orders from the users get processed by order management system 430. Order management system performs many different functions, such as processing payments and managing customer data. Of particular importance to embodiments are the signals provided to capacity tracking service 410. These signal can include capacity consumption due to new orders 432, capacity utilization due to shipments 434, and capacity un-consumption due to order cancellations 436. Order management system 430 also interacts with order prioritization service 454 and batch order optimization service 456. Each of these signals will be described in further detail below.

Another input to capacity tracking service 410 is planned fulfillment capacity 440. As described earlier, planned fulfillment capacity is an estimate of how many products can be processed by a particular warehouse in a single time period (typically a day). Planned capacity can include planned events 442 and unplanned events 444. For example, planned event 442 can comprise the available man-hours at a particular warehouse, the time of the week (e.g., more people might work on weekdays than weekends), and the time of the year (e.g., more people might work during the autumn due to higher sales numbers than during the summer). Planned event 442 can also take into account business negotiations, demand forecasting, and shift plans at the distribution center. Unplanned events 444 can include sick days taken by personnel, inclement weather, and communication outages.

Output from capacity tracking service 410 can be used by a variety of other modules. These modules can include order sourcing and promise date service 452, order prioritization service 454, and batch order optimization service 456. Order sourcing and promise date service 452 is arranged to use information from capacity tracking service 410 and an estimated delivery date to a customer to determine from which warehouse a shipment is made. Order sourcing and promise date service 452 also can be configured to display available promise dates. For example, due to fulfillment capacity, a particular order might not be available for overnight delivery. In such a situation, overnight delivery might not be displayed as an option for that order. In some embodiments, order sourcing and promise date service 452 can determine several different dates, such as the order processing date (the date when the order can be processed and boxed, dependent upon fulfillment capacity), estimated ship date (when a box can be picked up by a delivery service), and the estimated delivery date (when a box can be delivered to a customer). It should be clear that, while the estimated delivery date is the date of most importance to a customer, the estimated delivery date is dependent upon the estimated ship date and order processing date.

Order prioritization service 454 interacts with order sourcing and promise date service 452 by providing details about order prioritization. For example, some orders might have been ordered with overnight delivery and other orders might have been ordered with 2^{nd} day delivery. Order prioritization service 454 can be configured to inform warehouse personnel that certain orders should be packed or otherwise processed before other orders. In a similar manner, batch order optimization service 456 can be configured to process batch orders. A batch order is an amalgamation of multiple orders that can be processed together to more efficiently process the orders. For example, one batch of orders can be grouped regionally and assigned to one warehouse while another batch of orders can be grouped and assigned to a different warehouse.

Order prioritization service 454 and batch order optimization service 456 interact with order management system 430 to determine the most efficient shipment dates and methods.

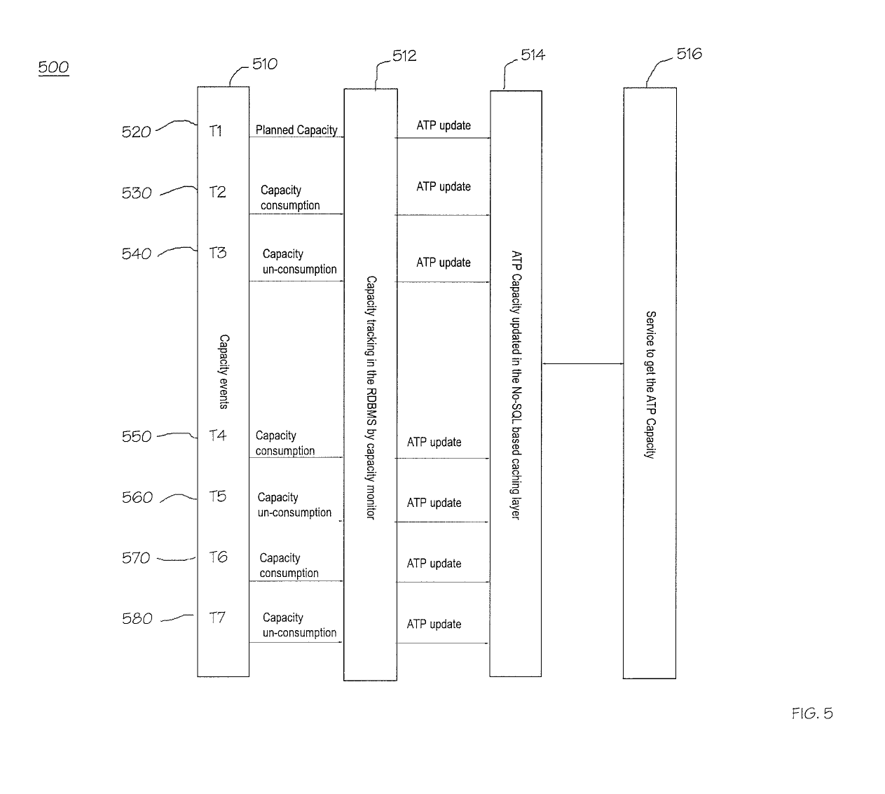

FIG. 5 will now show a diagram illustrating a method 500 of using fulfillment capacity. Method 500 is merely exemplary and is not limited to the embodiments presented herein. Method 500 can be employed in many different embodiments or examples not specifically depicted or described herein. In some embodiments, the procedures, the processes and/or the activities of method 500 can be performed in the order presented. In other embodiments, the procedures, the processes, and/or the activities of method 500 can be performed in any other suitable order. In still other embodiments, one or more of the procedures, the processes, and/or the activities of method 500 can be combined or skipped. In some embodiments, method 500 can be implemented by computer system 100 (FIG. 1). In some embodiments, method 500 can be implemented by central computer system 301 (FIG. 3). The numbers used in method 500 are merely illustrative. It should be understood that the process described in method 500 can be used with orders of any number of units. A warehouse used by a large eCommerce provider can have a fulfillment capacity measured in the thousands or tens of thousands units. Smaller units are illustrated in FIG. 5 for ease of discussion.

Column 510 illustrates capacity events that occur. Column 512 illustrates the output of capacity tracking service 410 in response to capacity events. It will be shown that a fulfillment capacity tracking service of an embodiment can keep track of fulfillment capacity and maintain a real-time estimate of the fulfillment capacity of a location. It will be understood that the fulfillment capacity of a location can be used to determine a location from which to fulfill an order. Column 514 illustrates the available to promise (ATP) capacity as updated in cache 416. Column 516 illustrates the data available to front-end 420.

At event 520, planned capacity is input into a fulfillment capacity tracking service. Illustrated in FIG. 5 is the input of two days of planned fulfillment capacity tracking. It should be understood that any number of days of planned fulfillment capacity can be input into a capacity tracking service. In the example given there, at initial time T1, the planned fulfillment capacity for date 1 is 100 units, and the planned fulfillment capacity for date 2 is 200 units, where date 1 is before date 2. Therefore, the fulfillment capacity tracking service publishes its available to promise (ATP) numbers of 100 for date 1 and 200 for date 2 (block 522).

At event 530, at subsequent time T2, there is an order of 10 units for date 1. The result in the fulfillment capacity tracking service is that the ATP number of date 1 is reduced by 10, making 90 the ATP for date 1, which is published by the fulfillment capacity tracking service (block 532).

At event 540, at subsequent time T3, there is a shipment of 10 units, fulfilling the order of event 530. This results in no change to the ATP of date 1 because the 10 units were expected to be shipped and 10 units were shipped. Thus, an ATP of 90 is published for date 1 again (block 542).

At event 550, at subsequent time T4, there is an order of 5 units for date 1. The result in the fulfillment capacity tracking service is that the ATP number of date 1 is reduced by 5, making the ATP 85 for date 1, which is published by the fulfillment capacity tracking service (block 552).

At event 560, at subsequent time T5, there is a shipment of 5 units for date 2 for the order of event 550 (date 2 is before date 1). Here, the shipment is early, as the shipment of the order was expected for date 1. This early shipment of the order is reflected in the ATP for both date 1 and date 2. Because the order was shipped on date 2, the fulfillment capacity on date 1 has to change to reflect the order no longer needs to be fulfilled on date 1. So the ATP of date 1 changed from 85 to 90. As for date 2, while it was originally expected that an order of 5 units would take place on date 1, that event will happened on date 2 and needs to be accounted for. Therefore, the ATP of date 2 is lowered by 5, from 200 to 195. Both of these ATP numbers are published (block 562).

At event 570, at subsequent time T6, there is an order of 2 units for date 1. The result in the fulfillment capacity tracking service is that the ATP number of date 1 is reduced by 2, making the ATP 88 for date 1, which is published by the fulfillment capacity tracking service (block 572).

At event 580, at subsequent time T7, there is a cancellation of the order for 2 units for date 1. A cancellation might be allowed by some eCommerce providers in order to provide a better user experience, as the users might be able to change their mind about a purchase for a certain time period after they place an order. A cancellation might occur due to the detection of fraud of a payment. A cancellation might occur because a product has become sold out. There can be a variety of reasons for an order cancellation. The result in the fulfillment capacity tracking service is that the ATP number of date 1 is increased by 2, making the ATP 88 for date 1, which is published by the fulfillment capacity tracking service (block 582).

The above are merely examples of events that can occur and the changes made to fulfillment capacity in response to those events. Other events can also be possible, such as product returns, changes to planned capacity due to weather, and the like.

The use of the fulfillment capacity is beyond the scope of the present specification. It should be understood that the ATP numbers published by a fulfillment capacity tracking service (such as capacity tracking service 410 of FIG. 4) can be used in a variety of different manners. For example, order sourcing and promise date service 452, order prioritization service 454, and batch order optimization service 456 can use the ATP numbers for both on the customer side (for example, displaying to a user a list of available delivery dates) and on the business side (for example, balancing orders between multiple warehouses).

While portions of the above disclosure discussed the usage of embodiments in conjunction by an eCommerce provider, it should be understood that embodiments are not so limited. Embodiments can be used in any situation in which it is desired to track the ability of an entity to ship or otherwise fulfill orders. Exemplary situations in which embodiments can be used can include shipping companies, drop ship vending companies, brick and mortar retail stores, and the like.

Although the above embodiments have been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 can be modified, and that the foregoing discussion of certain of these embodiments does not necessarily represent a complete description of all possible embodiments. For example, one or more of the procedures, processes, or activities of FIGS. 1-5 can include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processing modules; and
one or more non-transitory storage modules storing computing instructions configured to run on the one or more processing modules and perform the acts of:
determining an initial value for a fulfillment capacity of each location of one or more locations, such that the initial value for the fulfillment capacity is an estimation of how many units can be shipped from the location in a particular time period;
receiving orders;
adjusting the fulfillment capacity for each of the orders received;
publishing the fulfillment capacity as an availability to promise;
using the availability to promise to prioritize a set of one or more of the orders; and
processing one of the orders for shipment based on the prioritization.

2. The system of claim 1 wherein:
adjusting the fulfillment capacity further comprises adjusting the fulfillment capacity based on unplanned events.

3. The system of claim 1 wherein:
adjusting the fulfillment capacity further comprises adjusting the fulfillment capacity based on shipments from the location.

4. The system of claim 1 wherein:
adjusting the fulfillment capacity further comprises adjusting the fulfillment capacity based on cancellations of one or more of the orders.

5. The system of claim 1 wherein:
determining the initial values for the fulfillment capacity comprises evaluating weather conditions and available man-hours at the location.

6. The system of claim 1 wherein:
using the availability to promise to prioritize the set of one or more of the orders comprises evaluating the availability to process of a set of one or more locations to determine which location of the one or more locations will process each order of the set of the one or more of the orders.

7. The system of claim 1 wherein the computing instructions are further configured to perform the acts of:
using the availability to promise to determine an estimated delivery date for each order of the set of orders.

8. The system of claim 7 wherein the computing instructions are further configured to perform the acts of:
sending instructions to display the estimated delivery date to a customer.

9. The system of claim 1 wherein:
adjusting the fulfillment capacity for each of the orders received comprises decrementing the fulfillment capacity for each of the orders received.

10. The system of claim 11 wherein the computing instructions are further configured to perform the acts of:
using the availability to determine an estimated delivery date for each order of the set of orders;
sending instructions to display of the estimated delivery date to a customer; wherein:
adjusting the fulfillment capacity further comprises adjusting the fulfillment capacity based on unplanned events;
adjusting the fulfillment capacity further comprises adjusting the fulfillment capacity based on shipments from the location;
adjusting the fulfillment capacity further comprises adjusting the fulfillment capacity based on cancellations of orders;
determining the initial fulfillment capacity comprises evaluating weather conditions and available man-hours at the location;
using the availability to promise to prioritize orders comprises evaluating the availability to process of a set of one or more locations to determine which location of the one or more locations will process each order of the set of orders; and
adjusting the fulfillment capacity for each order placed comprises decrementing the fulfillment capacity for each order placed.

11. A method comprising:
determining an initial value for a fulfillment capacity of each location of one or more locations, such that the initial value for the fulfillment capacity is an estimation of how many units can be shipped from the location in a particular time period;
receiving orders;
adjusting the fulfillment capacity for each of the orders received;
publishing the fulfillment capacity as an availability to promise;
using the availability to promise to prioritize a set of one or more of the orders; and
processing one of the orders for shipment based on the prioritization.

12. The method of claim 11 wherein:
adjusting the fulfillment capacity further comprises adjusting the fulfillment capacity based on unplanned events.

13. The method of claim 11 wherein:
adjusting the fulfillment capacity further comprises adjusting the fulfillment capacity based on shipments from the location.

14. The method of claim 11 wherein:
adjusting the fulfillment capacity further comprises adjusting the fulfillment capacity based on cancellations of orders.

15. The method of claim 11 wherein:
determining the initial value for the fulfillment capacity comprises evaluating weather conditions and available man-hours at the location.

16. The method of claim 11 wherein:
using the availability to promise to prioritize the set of the one or more of the orders comprises evaluating the availability to process of a set of one or more locations to determine which location of the one or more locations will process each order of the set of the one or more of the orders.

17. The method of claim 11 further comprising:
using the availability to promise to determine an estimated delivery date for each order of the set of orders.

18. The method of claim 17 further comprising:
send instructions to display of the estimated delivery date to a customer.

19. The method of claim 11 wherein:
adjusting the fulfillment capacity for each of the orders received comprises decrementing the fulfillment capacity for each of the orders placed.

20. The method of claim 11 further comprising:
using the availability to determine an estimated delivery date for each order of the set of orders;
facilitating the display of the estimated delivery date to a customer; wherein:
adjusting the fulfillment capacity further comprises adjusting the fulfillment capacity based on unplanned events;
adjusting the fulfillment capacity further comprises adjusting the fulfillment capacity based on shipments from the location;
adjusting the fulfillment capacity further comprises adjusting the fulfillment capacity based on cancellations of orders;
determining the initial fulfillment capacity comprises evaluating weather conditions and available man-hours at the location;
using the availability to promise to prioritize orders comprises evaluating the availability to process of a set of one or more locations to determine which location of the one or more locations will process each order of the set of orders; and
adjusting the fulfillment capacity for each order placed comprises decrementing the fulfillment capacity for each order placed.
